(19) United States
(12) Patent Application Publication
(10) Pub. No.: US 2010/0106926 A1
(43) Pub. Date: Apr. 29, 2010

(54) SECOND FAILURE DATA CAPTURE PROBLEM DETERMINATION USING USER SELECTIVE MEMORY PROTECTION TO TRACE APPLICATION FAILURES

(75) Inventors: MADHUSUDANAN KANDASAMY, BUNGALOWPUDUR (IN); VIDYA RANGANATHAN, BANGALORE (IN)

Correspondence Address: PATENTS ON DEMAND, P.A.-IBM ACCSPP, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/258,397

(22) Filed: Oct. 25, 2008

(51) Int. Cl. G06F 12/14; G06F 12/02

(52) U.S. Cl. 711/163; 711/170; 711/E12.002; 711/E12.091

(57) ABSTRACT

The present invention discloses a solution for second failure data capture problem determination using user selective memory protection to trace application failures. In the solution, one or more data structures can be selected by a user to be allocated a unique address space from a debug heap. The address space called a region can be assigned permissions for which executable code can access the contents. Permissions can include full access (e.g., read/write), read, and no access which can “lock” the region against specific types of access. The user can permit known trusted executable code to access allocated regions. Untrusted executable code attempting to access “locked” regions will result in an application failure event (e.g., segmentation fault). The failure can be used to determine the point of memory corruption through inspection of the stack trace.

### BACKGROUND

The present invention relates to the field of problem determination and debugging and, more particularly, to second failure data capture problem determination using user selective memory protection to trace application failures.

Application crashes are frequently caused because of memory corruption occurring during application execution. One primary cause of memory corruption is memory access violations. This can occur when executable code unexpectedly writes to an area of memory that it should not. To determine where the problem occurs in applications, second failure data capture is often performed. This is commonly achieved through compiling and executing the offending application in with debugging options enabled. A problem that readily springs up with this approach is memory exhaustion. This is due to the allocation scheme that occurs with debugging. For instance, one byte of memory can be allocated two pages of memory. As such, any small applications when executing using debug memory allocation run out of allocated memory. The problem is further compounded when an application is large and utilizes a vast quantity of memory at any given execution point.

Additionally, large applications are often difficult to troubleshoot because of the enormous amount of code executing at any one point in time. Further, several pieces of executable code can be accessing the same and/or related memory areas which can cause the problem. Legacy applications often fail and generate an error much earlier than the actual problem due to another memory issue. What is needed is a means to determine the exact point of memory corruption in applications during second failure data capture.

### BRIEF DESCRIPTION OF THE SEVERAL VIEWS OF THE DRAWINGS

FIG. 1 is a schematic diagram illustrating a system for enhancing memory corruption detection during execution code debugging in accordance with an embodiment of the inventive arrangements disclosed herein.

FIG. 2 is a schematic diagram illustrating a set of interfaces for automating implementation of memory corruption detection using user assigned permissions for user selected memory regions in accordance with an embodiment of the inventive arrangements disclosed herein.

FIG. 3 is a schematic diagram illustrating a method for improving detection of memory corruption within executable code in accordance with an embodiment of the inventive arrangements disclosed herein.

### DETAILED DESCRIPTION

The present invention discloses a solution for second failure data capture problem determination using user selective memory protection to trace application failures. In the solution, one or more data structures can be selected by a user to be allocated a unique address space from a debug heap. The address space called a region can be assigned permissions for which executable code can access the contents. Permissions can include full access (e.g., read/write), read, and no access which can “lock” the region against specific types of access. The user can permit known trusted executable code to access allocated regions. Untrusted executable code attempting to access “locked” regions will result in an application failure event (e.g., segmentation fault). The failure can be used to determine the point of memory corruption through inspection of the stack trace.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer usable storage medium having computer usable program code embodied in the medium. In a preferred embodiment, the invention is implemented in software, which includes but is not limited to firmware, resident software, microcode, etc.

Furthermore, the invention can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The computer usable medium may include a propagated data signal with the computer usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer usable or computer readable medium may be, for example but not limited to, an electronic, magnetic, optical, electromagnetic, infrared, or semiconductor system, apparatus, device, or propagation medium. Examples of a computer readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer usable or computer readable medium can even include paper or another suitable medium upon which the program is printed, as the program can be electronically captured, for instance, via optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

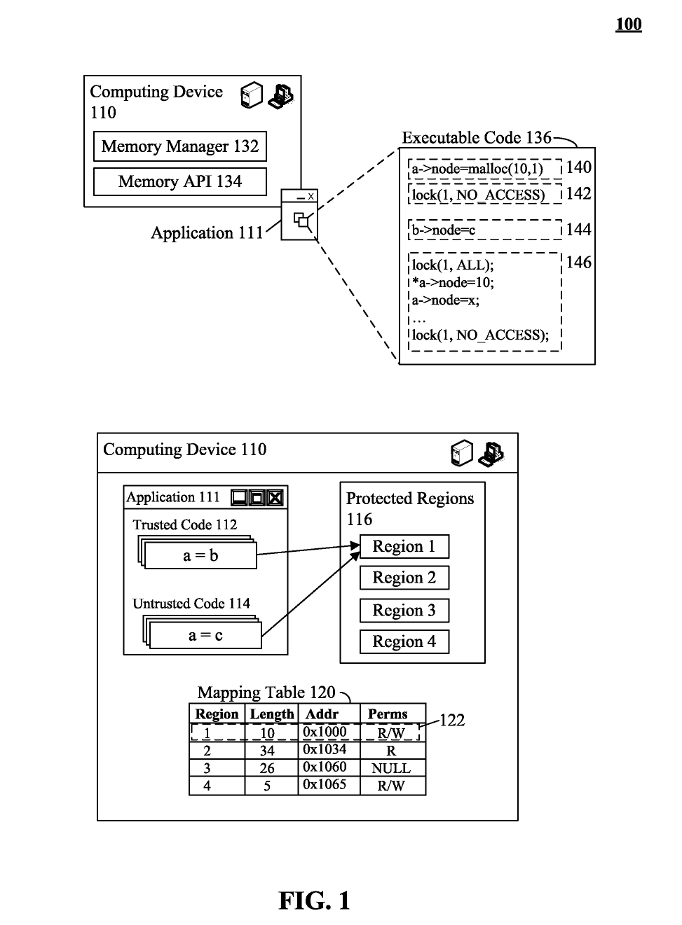

FIG. 1 is a schematic diagram illustrating a system 100 for enhancing memory corruption detection during execution code debugging in accordance with an embodiment of the inventive arrangements disclosed herein. In system 100, memory manager 132 and memory application programming interface (API) 134 can assist application developers in determining memory corruption issues. Memory manager 132 and memory API 134 can enable the developer to utilize permissions-aware memory access when debugging application 111. An application 111 executing on computing device 110 can include trusted code 112 and untrusted code 114 accessing memory regions 116. Trusted code can access protected regions 116 based on permissions granted by mapping table 120. For instance, entry 122 in table 120 permits read and write access to the memory area from trusted code 112. If untrusted code 114 attempts to access protected regions 116, the memory manager 132 can determine a permissions violation and initiate a failure notification and/or action.

As used herein, trusted code 112 can include executable code “expected” to access a region of memory which is corrupted during execution. Untrusted code 114 can include executable code which unexpectedly accesses a region of memory and results in memory corruption of that memory area.

As used herein, memory manager 132 can include software able to allocate and deallocate one or more regions of memory based on user selected permissions. Memory can be allocated from a debug heap which can include a multi-heap stack implementation. Manager 132 can track free blocks and used blocks of memory within the debug heap, enabling efficient usage of protected regions 116.

Protected regions 116 can include one or more segments of memory (e.g., pages) allocated from a heap which are associated with user selected permissions. Protected regions 116 can include a 32-bit and/or 64-bit addressable memory space. The region of memory can include one or more data structures which is affected by data corruption during code execution. Regions 116 can have a defined start address and end address handled by the memory manager 132.

Memory API 134 can include one or more permissions-aware dynamic memory allocation and deallocation functions. In one embodiment, the malloc( ) function call can be modified protect the data structure. For example, code 140 can allocate a linked list node with the region id of one. Permissions can be user configured through memory API 134 function calls. For instance, region 1 within protected regions 116 can be permission restricted against all types of access using a call 142 “lock(1, NO_ACCESS)”. API calls for freeing used regions can be implemented in a permissions aware manner.

Tested executable code 146 (e.g., trusted code) can be permitted to access protected regions using memory API 134 function calls. For instance, through memory API provided call code 146 can be granted full permissions to access region 1 of protected regions 116. At the end of trusted code, access can be revoked using a function call similar to the call used at the beginning of the trusted code.

In one scenario, logical error 144 can be detected and memory corruption can be identified rapidly where unconventional debugging methodologies fail. During execution code 144 is the source of the memory corruption performing a legal but unintended memory write. The error 144 can be identified when code 144 attempts to write to the data structure “locked” in code segment 142. Memory manager 132 can perform a permissions lookup on the protected data structure (e.g., region 1) using mapping table 120. The permissions entry in the table can indicate no access is permitted and the memory manager 132 can respond appropriately. In one embodiment, manager 132 can throw a segmentation fault error such as SIG_SEGV, causing the application to abort and perform error reporting. Inspection of the error reporting can include examination of the stack trace log which can indicate the source of corruption as code segment 144.

Drawings presented herein are for illustrative purposes only and should not be construed to limit the invention in any regard. The invention should not be limited to application debugging but can be applied to debugging any software where memory corruption issues arise. Although the invention is presented utilizing C/C++ executable code and malloc( ) function calls, other embodiments are contemplated using different programming languages and APIs.

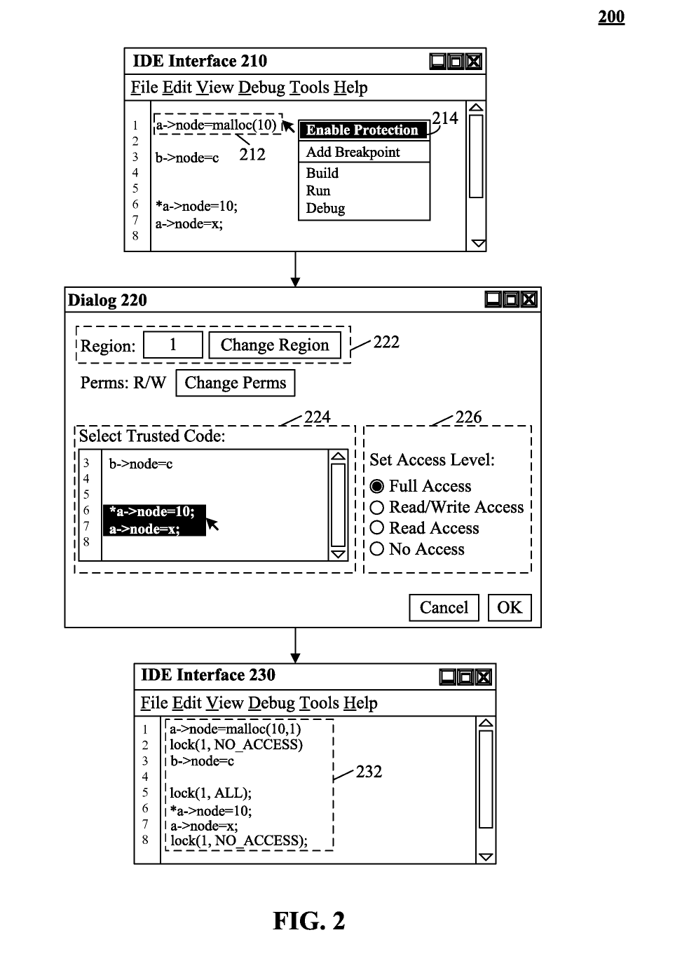

FIG. 2 is a schematic diagram illustrating a set of interfaces 210-230 for automating implementation of memory corruption detection using user assigned permissions for user selected memory regions in accordance with an embodiment of the inventive arrangements disclosed herein. In interfaces 210-230, a user can select a data structure within a code segment for which memory protection is to be enabled. The user can be presented with a dialog 220 to select permissions for the data structure and one or more trusted code segments. Upon acceptance of dialog 220, interface 230 can present modified source code 230.

In interface 210, data structure memory protection can be enabled through one or more interface options. For instance, data structure 212 can be protected through a context menu entry 214. Interface options can include, but is not limited to, pull down menus, shortcut key bindings, and the like. In one embodiment, data structure memory protection options can be presented simultaneously with other traditional menu entries of an integrated development environment (IDE). Selection of option menu entry 214 can result in the presentation of dialog 220

In dialog 220, the user can select data structure memory protection information 222 and trusted code access 224-226. The user can assign the region id for which the data structure can be associated. The region id can be automatically assigned by the system (e.g., memory manager) based on available region ids. Optionally the user may select from a list of available region ids using interface artifacts such as drop down menus, interactive buttons, and the like. Region permissions can be automatically assigned based on default configuration options present in the IDE. The user can optionally modify permissions through available interface artifacts. Trusted code can be configured to specifically access the specified data structure in a user configured manner. For instance, the user can select trusted code through interface artifact 224 and assign an appropriate access permission using artifacts 226.

Once the suitable assignments have been performed the IDE can modify the selected code (e.g., data structure instruction and trusted code) accordingly. Interface 230 can present modified code 232 which can include permission-aware memory application programming interface (API) calls. Alternatively, the user can manually insert the proper memory calls to protect the data structures and permit access to trusted code where necessary. In one embodiment, the automatically and manually attributed memory calls can be recognized by the IDE and modification of the calls can be further performed through dialog 220. In another embodiment, the modified code 232 can be intermediate code used by a debugger, which is not made to source code. That is, marking of different code sections can be a debugging change which leaves source code unmodified. In still another embodiment, instead of explicitly modifying code 232, debugger specific software parameters and the like can be modified, without modifying any actual code (232) being executed.

Drawings presented herein are for illustrative purposes only and should not be construed to limit the invention in any regard. Although presented within the context of an IDE editor, the invention is not limited in this regard. In one embodiment, the functionality can be present within RATIONAL PURIFY instrumentation. Other possible embodiments are contemplated wherein the functionality is encapsulated within a debugger, a sandbox, a secure computing environment, and the like.

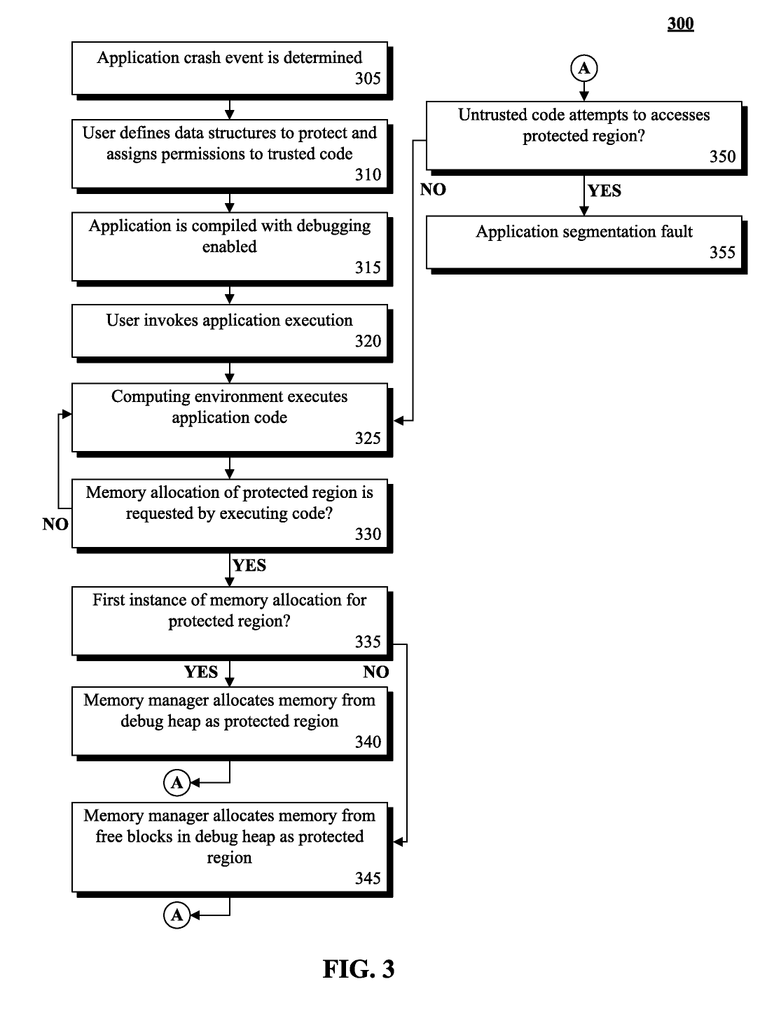

FIG. 3 is a schematic diagram illustrating a method 300 for improving detection of memory corruption within executable code in accordance with an embodiment of the inventive arrangements disclosed herein. Method 300 can be performed in the context of system 100. The method 300 can be implemented within a 32-bit and/or 64-bit address space. In method 300, a user selectable memory locking mechanism can be used to debug an application containing memory corruption problems. Based on a previous application failure, an application developer can determine data structures which are corrupted during execution. The developer can assign permissions to the region of memory which the data structures are allocated using a permissions-aware memory manager and memory application programming interface (API). One or more segments of problematic executable code which require debugging can be given no permissions to access the identified data structures. When executable code attempts to access the permission restricted region of memory, the memory manager can invoke a segmentation fault. The segmentation fault can permit developers to determine the exact location of memory corruption within the application executable code through inspection of the stack trace.

In step 305, an application crash event is determined through automated application monitoring or by manual application/process inspection. In step 310, the user defines data structures to protect and assigns permissions to trusted code. The data structures which require protection can be accessed normally by trusted code assuming full permissions are given to the trusted code. In step 315, the application is compiled with debugging enabled, if necessary. In one embodiment, compile time options can include a “-g” compile time flag necessary for enabling debugging code within the executable application.

In step 320, the user invokes application execution. In step 325, the computing environment executes application code. Application execution can be performed in a secure computing environment, application/system sandbox, integrated development environment (IDE), and the like. In step 330, if a memory allocation of protected region is requested by executing code, the method can continue to step 335, else return to step 325. In step 335, if the request is first instance of memory allocation for the protected region, the method can continue to step 340, else proceed to step 345.

In step 340, the memory manager allocates memory from the debug heap as the protected region. In one embodiment, the debug heap can be a multi-heap implementation able to support numerous individual heaps within a larger memory address space. In step 345, the memory manager allocates memory from free blocks in debug heap as the protected region. In step 350, if untrusted code attempts to access the protected region, the method can continue to step 355, else return to step 325. In step 355, the application can segmentation fault can occur. In one embodiment, the application can send a SIG_SEGV signal or an equivalent failure notice to a system/user component.

Once the segmentation fault occurs (or some other action resulting from a read/write denial occurs) other programmatic actions can execute which are useful in a debugging context. For example, in one embodiment, a portion of the programmatic code (e.g., the untrusted code of step 350), which was denied access to the protected region can be displayed within a debugging interface. Alternatively, a log of the denial can be written to a file, which indicates which portion of source code attempted to write to the protected memory.

denying a read or a write attempt involving the region of computer usable memory based upon the permission level; and

showing a portion of the programmatic code which was denied access to the computer useable memory within a debugging application.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for detecting memory corruption occurrences comprising:
receiving a user input for a data structure within programmatic code;
marking a block of the programmatic code in accordance with user input with a permission level, wherein another portion of the programmatic code is associated with another permission level;
executing the programmatic code;
allocating a region of computer usable memory to the data structure during execution of the programmatic code; and
programmatically permitting access to the allocated region of computer usable memory while executing the programmatic code depending on the permission level of the block of the programmatic code which initiated the access.

2. The method of claim 1, wherein the permission level is user configurable via a graphical user interface, wherein configurable values for the permission level comprise at least one of a read permission and a write permission, wherein one of the marked portion and the another portion is enabled for the configured permission level and wherein the other one of the marked portion and the another portion is disabled for the configured permission level, said method further comprising:
presenting the programmatic code within the graphical user interface;
upon receiving the user input, presenting a protection option within the graphical user interface for enabling protection for the data structure; and
responsive to a user selection of the protection option, presenting an option in the graphical user interface that permits the block of the programmatic code to be selected, wherein the user input for marking of the block of programmatic code is received from input entered into the graphical user interface that permits the block of the programmatic code to be selected.

3. The method of claim 1, further comprising:
denying a read or a write attempt involving the region of computer usable memory based upon the permission level; and
showing within a user interface a portion of the programmatic code which was denied access to the computer useable memory within a debugging application, wherein a region of the allocated memory associated with the marked blocks having the permission level is unknown when the user input is received, and wherein a user input is not required that explicitly defines addresses of the computer usable memory.

4. The method of claim 1, wherein the marking of the block is a debugging change which leaves source of the programmatic code unmodified, and wherein the allocated memory is allocated from a debug heap.

5. A computer program product for detecting memory corruption occurrences comprising:
a computer readable storage medium that is a physical storage medium having computer usable program code embodied therewith, the computer usable program code comprising:
computer usable program code configured to receive a user input for a data structure within programmatic code;
computer usable program code configured to mark a block of the programmatic code in accordance with user input with a permission level, wherein another portion of the programmatic code is associated with another permission level;
computer usable program code configured to execute the programmatic code;
computer usable program code configured to allocate a region of computer usable memory to the data structure during execution of the programmatic code; and
computer usable program code configured to programmatically permit access to the allocated region of computer usable memory while executing the programmatic code depending on the permission level of the block of the programmatic code which initiated the access.

6. The computer program product of claim 5, wherein the permission level is user configurable via a graphical user interface, wherein configurable values for the permission level comprise at least one of a read permission and a write permission, wherein one of the marked portion and the another portion is enabled for the configured permission level and wherein the other one of the marked portion and the another portion is disabled for the configured permission level, said computer usable program code further comprising:
computer usable program code configured to present the programmatic code within the graphical user interface;
computer usable program code configured to, upon receiving the user input, present a protection option within the graphical user interface for enabling protection for the data structure; and
computer usable program code configured to, responsive to a user selection of the protection option, present an option in the graphical user interface that permits the block of the programmatic code to be selected, wherein the user input for marking of the block of programmatic code is received from input entered into the graphical user interface that permits the block of the programmatic code to be selected.

7. The computer program product of claim 5, further comprising:
computer usable program code configured to deny a read or a write attempt involving the region of computer usable memory based upon the permission level; and
computer usable program code configured to show within a user interface a portion of the programmatic code which was denied access to the computer useable memory within a debugging application, wherein a region of the allocated memory associated with the marked blocks having the permission level is unknown when the user input is received, and wherein a user input is not required that explicitly defines addresses of the computer usable memory.

8. The computer program product of claim 5, wherein computer usable program code that marks the block is a debugging change which leaves source of the programmatic code unmodified, and wherein the allocated memory is allocated from a debug heap.
